(19) United States
(12) Patent Application Publication
(10) Pub. No.: US 2025/0156299 A1
(43) Pub. Date: May 15, 2025

(54) INPUT SPACE CERTIFICATION FOR A BLACK BOX MACHINE LEARNING MODEL

(71) Applicant: INTERNATIONAL BUSINESS MACHINES CORPORATION, ARMONK, NY (US)

(72) Inventors: Amit Dhurandhar, Yorktown Heights, NY (US); Swagatam Haldar, Kolkata (IN); Dennis Wei, Sunnyvale, CA (US); Karthikeyan Natesan Ramamurthy, Pleasantville, NY (US)

(21) Appl. No.: 18/509,625

(22) Filed: Nov. 15, 2023

(51) Int. Cl. G06F 11/34

(52) U.S. Cl. CPC G06F 11/3447

(57) ABSTRACT

A method, computer program product, and computer system for certifying a d-dimensional input space x for a black box machine learning model. Triggered is execution of a first process that certifies, with respect to the model, a maximum subspace of x that is characterized by a largest half-width or radius (w) centered at x=x₀. Received from of the first process are: w and both (i) a point rₑ selected from multiple points r randomly sampled in the maximum subspace, and (ii) a quality metric f(rₑ), where rₑ and f(rₑ) were previously determined from the model having been queried for each point r randomly sampled in the maximum subspace, where rₑ is selected on a basis of f(rₑ) satisfying f(rₑ)≥θ for a specified quality threshold θ. The model is executed for input confined to the maximum subspace, which performs a practical application procedure that improves performance of the model.

### BACKGROUND

The present invention relates to improving use of a black box model, and more specifically, to certifying an input space for a black box machine learning model.

### SUMMARY

Embodiments of the present invention provide a method, a computer program product, and a computer system, for certifying a d-dimensional input space x for a model, wherein the model is a black box machine learning (ML) model, and wherein d is at least 1.

One or more processors of a computer system, trigger execution of a first process (Ecertify) that certifies, with respect to the model, a maximum subspace of x that is characterized by a largest half-width or radius (w) centered at x=X₀.

The one or more processors receive, from execution of the first process, w and both (i) a point re selected from multiple points r randomly sampled in the maximum subspace, and (ii) a quality metric f(rₑ), wherein rₑ and f(rₑ) were previously determined from the model having been queried for each point r randomly sampled in the maximum subspace, wherein rₑ was selected on a basis of f(rₑ) having been determined to have a minimum value in comparison to a value of f(r) for all points r randomly sampled in the maximum subspace, and wherein f(rₑ) satisfies f(rₑ)≥0 for a specified quality threshold θ.

The one or more processors execute the model for input confined to the maximum subspace, wherein executing the model includes performing a practical application procedure that improves performance of the model.

### BRIEF DESCRIPTION OF THE DRAWINGS

FIG. 1 depicts a computing environment which contains an example of an environment for the execution of at least some of the computer code involved in performing the inventive methods, in accordance with embodiments of the present invention.

FIG. 2 is a flow chart of a method for certifying a d-dimensional input space x for a model, in accordance with embodiments of the present invention.

FIG. 3 is a flow chart describing a first process used in the method of FIG. 2, in accordance with embodiments of the present invention.

FIG. 4 is a flow chart describing a second process used in the first process of FIG. 3, in accordance with embodiments of the present invention.

FIG. 5 is a flow chart describing a Uniform (unif) sampling strategy used in the second process of FIG. 4, in accordance with embodiments of the present invention.

FIG. 6 is a flow chart describing a Uniform Incremental (unifI) sampling strategy used in the second process of FIG. 4, in accordance with embodiments of the present invention.

FIG. 7 is a flow chart describing a Adaptive Incremental (adaptI) sampling strategy used in the second process of FIG. 4, in accordance with embodiments of the present invention.

FIG. 8 illustrates a computer system, in accordance with embodiments of the present invention.

### DETAILED DESCRIPTION

### 1. Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium or one or more computer readable storage media or a computer readable hardware storage device or one or more computer readable hardware storage devices, as such terms are used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

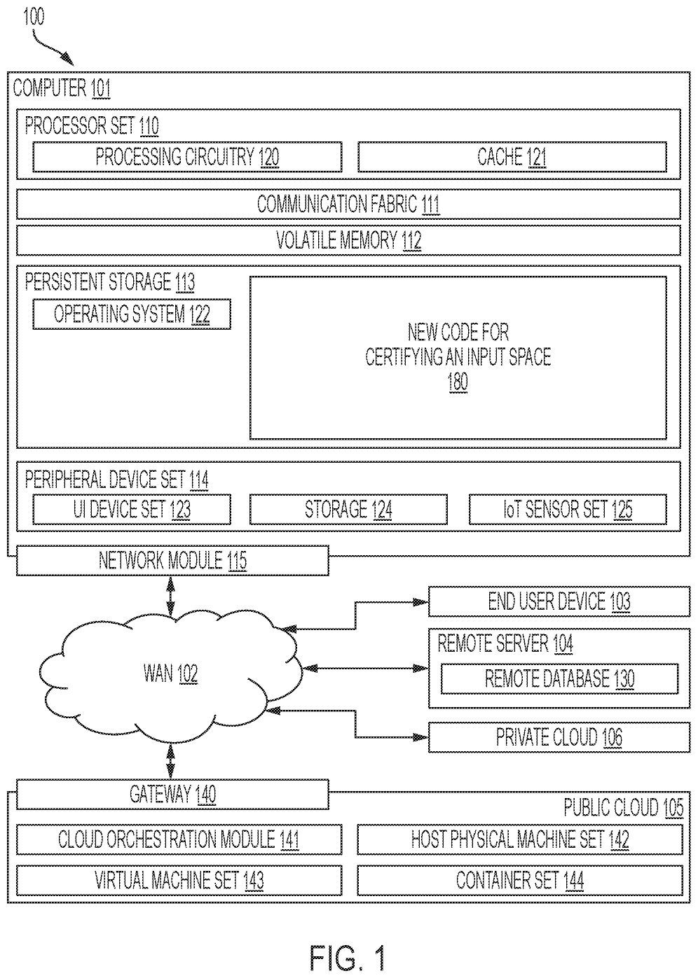

FIG. 1 depicts a computing environment 100 which contains an example of an environment for the execution of at least some of the computer code involved in performing the inventive methods, in accordance with embodiments of the present invention. Such computer code includes new code for certifying an input space for a model 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### 2. Introduction

Embodiments of the present invention certify/validate existing explanations for any predictive model such as a machine learning (ML) model. Given the model, the model's prediction for an input, the model's explanation for the input, a quality metric of faithfulness/quality of the explanation to the model, and a quality threshold, embodiments of the present invention find the largest “region” around the input where the explanation remains “valid” due to the quality metric being equal to or greater than the quality threshold.

Given the black box nature of machine learning (ML) models, a plethora of methods for explaining ML models have been developed to decipher the factors behind individual decisions.

A black box model is a model that generates output without revealing any information about the internal workings of the model, so that explanations for the generated output are “black” (i.e., not visible). The term “black box model” used in embodiments of the present invention is defined to be a black box machine learning (ML) model.

Embodiments of the present invention encompass a d-dimensional hyperspace whose geometry is either: (i) hyper-cubical characterized by hypercubes referenced to a spatial origin X₀ or (ii) hyper-spherical characterized by hyperspheres having radii with respect to a radial center X₀. Descriptions herein mentioning hypercubes or other aspects of a hyper-cubical geometry apply likewise to a hyper-spherical and vice versa.

Embodiments of the present invention tackle a largely unexplored problem of explanation certification, by answering the question: given a black box model (e.g., a machine learning (ML) model) with only query access, an explanation of a black box model for an example of specified input, and a quality metric (e.g., fidelity, stability), can a region of a largest hypercube (i.e., l_{∞} ball) centered at the example be found, such that when the explanation is applied to all examples within the region of the hypercube, a quality criterion is met (e.g., fidelity greater than some threshold value)?

Embodiments of the present invention answer the preceding question in the affirmative and consequently provide benefits such as, inter alia, i) providing insight into the behavior of the black box model over the region of the largest hypercube, with a quality guarantee, rather than just at the example of specified input; ii) ascertaining a stability of explanations, which has recently been shown to be important for stakeholders performing model improvement, domain learning, and adapting control and capability assessment; iii) explanation reuse, which can save time and work by not having to find explanations for every example; and iv) a possible meta-metric to compare explanation methods.

Contributions of embodiments of the present invention include formalizing the problem associated with the preceding question, providing solutions, analyzing these solutions, and experimentally showing efficacy of the solutions on synthetic and real data.

Numerous feature based local explanation methods have been proposed to explain individual decisions of black box models. However, these proposed methods in general do not include guarantees of how stable and widely applicable the explanations are likely to be. Explanations are typically found for each individual example of interest by invoking these methods as many times.

Since embodiments of the present invention only query access to the black box model, the setting is model agnostic and hence quite general. Furthermore, note that the explanation methods being certified could be model agnostic or white-box. The certification methods provided by embodiments of the present invention require only that the explanation method can compute explanations for different examples, with no assumptions regarding internal mechanisms of the black box model.

Contributions provided by embodiments of the present invention include: 1) formalizing the problem of explanation certification; 2) providing an approach called Explanation certify (Ecertify) with three sampling strategies of increasing complexity; 3) analyzing the whole approach by providing finite sample exponentially decaying bounds along with further analysis of special cases; and. 4) evaluating the quality of the inventive approach of embodiments of the present invention on synthetic data, demonstrating a utility of the inventive approach.

### 3. Problem Formulation

In this invention description, each parameter is a scalar, vector, or matrix. A parameter that is a vector or matrix may be specifically identified as such or may be inferred as such from the context in which such parameters appear. For example, if a parameter b is specifically identified as a vector a of dimension n and a parameter c is not identified as a vector, if the expression (a+c) appears then it may be inferred that c is a vector of dimension n. Note that a parameter specified as a vector of dimension 1 is also a scalar.

In this invention description, all operations between vectors and scalars are element-wise, [[n]] denotes the set {1, . . . , n} for any positive integer n, and log(.) is base 2.

In mathematics and in this invention description, the dot (.) in the notation of a function f(.) represents a placeholder for the input (i.e., one or more input variables) of the function f.

Let X×Y denote the input-output space where X⊆R^{d}, wherein R^{d} denotes a d-dimensional space of real numbers. Input includes: a predictive model g which is a black-box model: R^{d}→R; an example x₀∈R^{d} for there is a local explanation function eₓ₀: R^{d}→R; and a quality metric h: R²→R (higher the better, e.g., fidelity, stability, etc.). Note that eₓ₀(x) denotes the explanation computed at x₀ applied to x, wherein x and x₀ are each a vector of dimension d. For instance, if the explanation is linear, the feature importance vector of x₀ is multiplied by x. The explanation can alternatively be a non-linear explanation too, such as a (shallow) tree or a (small) rule list. For ease of exposition, the quality metric will be henceforth referred to as fidelity, although embodiments of the present invention may utilize any such metric. The input also includes a quality threshold θ. Embodiments of the present invention provide methods for finding the largest l∞ ball B_{∞} (x₀,w) centered at x₀ with radius w (or half-width w) such that ∀x ∈B_{∞}(x₀,w), fₓ₀(x)≙h (eₓ₀(x), g(x)≥0 as expressed in Equation (1), wherein g(x) denotes the back box model, and wherein V denotes “for each”.

$$max w such that {f}_{x 0} ( x ) \geq θ ∀ x ∈ {B}_{∞} ( {x}_{0} , w ) \qquad ( 1 )$$

Solving Equation (1) for is a challenging search problem, even if a region is fixed by setting the radius w (or half-width w) to some finite value, since checking whether the fidelity fₓ₀(x)≥θ for all x within the region is infeasible as the set of all x is uncountably infinite. Moreover, there is no known a priori upper bound on w. Thus, for arbitrary g(.), where g(.) denotes a black box region query via Algorithm 2 discussed infra, given that only query access and a finite query budget (i.e., number of queries) is available, Equation (1) can only be solved approximately to certify a region defined by w. Nonetheless, embodiments of the present invention correctly certify a region with high probability, converging to certainty as the budget tends to infinity, while also being computationally efficient. Computational efficiency is highly beneficial, since scenarios exist in which certified regions for explanations on entire, very large datasets are to be obtained. Sometime embodiments of the present invention equivalently query f(.), rather than querying g(.) and computing f(.).

Note that x is a vector of dimension d of features processed by the black box model. The feature may encompass any input parameters used by the black box model (e.g., geometric features, text features, types of materials, physical properties of materials, etc.). In one embodiment, x includes, or consists of, a physical space, for which d=1 denotes a one-dimensional space, d=2 denotes a two-dimensional space, etc. The number of features (d) of the black box model is any positive integer such as, inter alia, 1, 2, 3, . . . , 100, 1000, 10000, etc.

### 4. Method

Embodiments of the present invention utilize Algorithm 1 (Explanation certify (Ecertify) in Table 1) and Algorithm 2 (Certify in Table 2).

TABLE 1
Algorithm 1: Explanation certify (Ecertify)

Input:
example to be certified x; quality metric f(.) (e.g., fidelity); quality threshold θ; number
of regions to check Z; query budget per region Q; lower bound half-width (lb); upper
bound half-width (ub); certification strategy to use (s = {unif, unifI, adaptI})
Initialize: Currbst = 0, B = ∞
if f(x) < θ then Output: −1 # Size of certification set is 0.
for z = 1 to Z do

| \| | σ = (ub − lb) / d #Standard deviation of Gaussians in unifI and adaptI | |
|---|---|---|
| \| | (t, b) = Certify(lb, ub, Q, θ, f(.), x, σ) | |
| \| | # Find half-width of hypercube pr radius to certify | |
| \| | if t = = True then | |
| \| | \| | Currbst = ub, lb = ub, ub = min ((B+ub)/2, 2ub) |
| \| | else | |
| \| | \| | B = min {\|bᵢ − xᵢ\| such that \|bᵢ − xᵢ\| > lb ∀ i ∈ [[d]]} |
| \| | \| | ub = (B+lb)/2 |

Output: Currbst

TABLE 2
Algorithm 2: (t, b) = Certify (lb, ub, Q, θ, f(.), x, s)

Let R = [x + ub, x − ub] \ [x + lb, x − lb] be the region to query and let q = Q / log(Q)
# Choose sampling strategy as Uniform, Uniform Incremental or Adaptive Incremental
if s = = unif then

| | |
|---|---|
| \| | Uniformly sample Q examples r₁, ..., r_{Q} ∈ R and query f(.) |
| \| | Let rₑ = arg min f(rᵢ) selected from {r₁, ..., r_{Q}} |
| \| | if f(rₑ) ≥ θ then Output (True, rₑ, f(rₑ)) else Output: (False, rₑ, f(rₑ)) |

else if s = = unifI then

| \| | for i = 1 to └log(Q)┘ do | |
|---|---|---|
| \| | \| | Let n = min(2ⁱ, q) |
| \| | \| | Uniformly sample n examples (a.k.a. prototypes) r₁, ..., rₙ in R |
| \| | \| | Sample q/n examples (in R) from each Gaussian N(rⱼ, σ²I)(j∈ [[n]]; query f(.) |
| \| | \| | Let rₑ be the minimum fidelity example amongst the queried examples |
| \| | \| | if f(rₑ) < θ then Output: (False, rₑ, f(rₑ)) |

| | |
|---|---|
| \| | Output: (True, rₑ, f(rₑ)) |

else if s = = adaptl then

| \| | for i = 1 to log(Q) do | | |
|---|---|---|---|
| \| | \| | if i2ⁱ ≤ q then n = 2ⁱ, k = i else n = 2^{k} | |
| \| | \| | Let m = n | |
| \| | \| | Uniformly sample m examples (a.k.a. prototypes) r₁, ..., rₘ in R | |
| \| | \| | for j = 1 to log(n) do | |
| \| | \| | \| | Sample q/(mlog(n)) examples (in R) from each Gaussian N(rₖ, σ²I) |
| \| | \| | \| | where rₖ belongs to (selected) m prototypical examples and query f(.) |
| \| | \| | \| | Find the minimum fidelity example (mfe) for each of the m Gaussians |
| \| | \| | \| | Let rₑ = the mfe among these Gaussians |
| \| | \| | \| | if f(rₑ) < θ then Output: (False, rₑ); otherwise, select the m/2 prototypes |
| \| | \| | \| | which are associated with the lowest minimum fidelity examples and |
| \| | \| | \| | set m = m/2 |

| | |
|---|---|
| \| | Output: (True, rₑ, f(rₑ)) |

Algorithm 1 in Table 1 decides which finite region to certify based on whether the previous region was certified or not. The actual certification of a region occurs in Algorithm 2 based on an inputted sampling strategy of three sampling strategies. Then, depending on the outcome of the inputted sampling strategy, the size of the region to be next certified is either expanded (e.g., doubled in one embodiment) or contracted (e.g., halved in one embodiment) between the current region and the last found certified region, which will continue until a pre-specified number of iterations (Z) have been performed, after which the largest certified region found thus far is outputted. If an upper bound B, indicative of a region that is not certified, is already found, then once a smaller region within the not certified region is certified, the next region to be checked for certification will be, in one embodiment, midway between the smaller certified region and B. The lower bound (lb) will be 0 initially in one embodiment, unless the lower bound is determined by a region that is surely known to have been certified. As discussed infra, if g(.) is known to be lipschitz for instance, then a higher lb value could be set, given also a linear explanation function.

Table 2 is a schematic of Algorithm 2: Certify, in accordance with embodiments of the present invention.

Although a hypercube around an example x₀ is to be certified, Algorithm 1 invokes Algorithm 2 to certify regions between hypercubes with half-width lb and ub, since the region with half-width lb has already been certified at that juncture. Hence when certifying a larger region ub, queries need not be wasted on examples that lie inside lb. Embodiments of the present invention utilize the query budget Q efficiently for the region which exists between the lb and ub and which has not yet been certified, wherein Q is an inputted number of queries of the black box model. Examples are thus sampled from within the larger hypercube bounded by ub, and only those examples that lie outside the smaller hypercube bounded by lb are queried.

In one embodiment, σ×1/d is employed in Algorithm 1 since it becomes easier, with increasing dimension d, for an example sampled from a Gaussian to lie outside the hypercube as all dimensions need to lie within the specified ranges.

In Algorithm 2, three sampling strategies (unif, unifI, and adaptI) are available.

The first sampling strategy uniform (unif) is a uniform random sampling strategy that queries g(.) in the region specified by Algorithm 1. If the fidelity is met for all examples queried, then a boolean value of True is returned, otherwise False is returned along with the example where the fidelity was the worst.

The second sampling strategy is a uniform incremental (unifI) characterized by uniform random sampling at each iteration (i.e.; from 1 to log Q) of a set of n examples, followed by using the random samples as centers of a Gaussian from which q/n random examples are sampled. Again, examples belonging to the region are queried and True or False (with the failing example) is returned. This method is performing a dynamic grid search over the region in an incremental fashion in an attempt to certify the region.

The third strategy is adaptive incremental (adaptI), where as in unifI, uniform sampling is performed at random sample centers or prototypical examples, followed by adaptively deciding how many examples to sample around each prototype depending on how promising each prototype was in finding the minimum quality example. At each stage in the innermost loop, half of the most promising prototypes are chosen, followed by sampling more examples around the chosen prototypes until a single prototype is reached or a violating example is found. This method thus focuses the queries in regions where it is most likely to find a violating example. This invention disclosure infra discusses scenarios in which the total query budget is still Q for each of the strategies and there are any (probabilistic) performance guarantees that can be derived.

### 5. Analysis

Without loss of generality, x is assumed, in one embodiment, to be at the origin; i.e., x=0. Then any hypercube of (half-) width a, where a≥0, can be denoted by [−a, a]^{d}, wherein d is dimensionality of the space. Let fₐ* be the minimum fidelity value in region [−a, a]^{d}, and let \hat{f}ₐ* be the estimated minimum fidelity in the region [−a, a]^{d}, based on the methods mentioned in Algorithm 2. If [−a, a]^{d} is the region outputted by one of the sampling strategies in Algorithm 2, then the probability that this region is certified (i.e. fₐ*≥θ) is determined and that no larger region [−b, b]^{d} (where b>a) is certified. Formally, if \hat{f}ₐ*−θ=ϵₐ for some ϵₐ≥0 and θ−\hat{f}_{b}*32 ϵ_{b} for some ϵ_{b}>0 wherein \hat{f}_{b}* is the estimated minimum fidelity in the larger region [−b, b]^{d}, the following probability is lower bounded in Equation (2).

$$P [ {\hat{f}}_{a}^{*} - {f}_{a}^{*} \leq {ϵ}_{a} , {f}_{b}^{*} - {\hat{f}}_{b}^{*} \leq {ϵ}_{b} ] \qquad ( 2 )$$

Algorithm 1 doubles or halves the range every time a region is certified or failed to be certified, respectively. Hence, to certify the final region [−a, a]^{d}, O(log(a)) steps are taken. Without loss of generality, if it is assumed that the number of subsets of [−a, a]^{d} certified by Algorithm 1 is c, then the number sets found to have examples with fidelity less than θ is c′=O(log(a))−c. Let a₁, . . . , a_{c} denote the upper bounds of the certified regions with increasing value, where a_{c}=a, and let b₁, . . . , b_{c′} denote the upper bounds with increasing value for the remaining regions that failed certification, where b₁=b. Let f_{j,i}^{(x)} denote the fidelity of an example x in between two hypercubes [−j, j]^{d} and [−i, i]^{d} where j≥i≥0. Given that the certification strategies sample examples independently, and hence certification in a region is independent of the certification in a disjoint region, Lemma 1 is as follows, wherein if i=0, f_{j,i}^{(x)} is written as fⱼ^{(x)} for simplification.

Lemma 1. Equation (2) is lower bounded as follows:

$$\begin{matrix}P [ {\hat{f}}_{a}^{*} - {f}_{a}^{*} \leq {ϵ}_{a} , {f}_{b}^{*} - {\hat{f}}_{b}^{*} \leq {ϵ}_{b} ] \geq min {P [ {\hat{f}}_{′}^{*} {a}_{i} , {a}_{i - 1} - {f}^{*} {a}_{i} , {a}_{i - 1} \leq {ϵ}_{ai} ]}^{c} \\ i \text{?} \{ 1 , … , c \} \\ where {a}_{0} = 0 , {b}_{0} = a , {ϵ}_{ai} \geq 0 , {ϵ}_{bj} \geq 0 ∀ i ∈ \{ 1 , … , c \} , ∀ j ∈ \{ 1 , … , {c}^{′} \} .\end{matrix} \qquad ( 3 )$$

$$\text{?} \text{indicates text missing or illegible when filed}$$

From equation 3 it is clear that there is a need to lower bound P[\hat{f},*aᵢ,aᵢ₋₁−f*aᵢ,aᵢ₋₁≤ϵₐᵢ]∀i∈{1, . . . , c}. Since, the form of the bounds will be similar ∀i, let for simplicity of notation denote the fidelities for the i^{th} region by just the suffix i; i.e., denote f* aᵢ,aᵢ₋₁ by fᵢ* and the minimum estimated fidelity and fidelities for other examples in that region. There is thus a need to lower bound P[\hat{f}ᵢ*−fᵢ*≤ϵᵢ] for the three different certification strategies of unif, unifI, and adaptI.

The uniform strategy (unif) is the simplest strategy where Q examples are sampled and queried uniformly in the region to be certified. Let U denote the uniform distribution over the input space in the i^{th} region and let Fᵢ^{(u)}(.) denote the cumulative distribution function (cdf) of the fidelities induced by this uniform distribution; i.e., Fᵢ^{(u)}(v)≙P_{r˜U}[\hat{f}ᵢ^{(r)}≤v] for some real v and r in the i^{th} region.

Lemma 2. The lower bound of the error probability of unif in a region I is given by Equation (4).

$$P [ {\hat{f}}_{i}^{*} - {f}_{i}^{*} \leq {ϵ}_{i} ] \geq 1 - exp ( - {QF}_{i}^{( u )} ( {f}_{i}^{*} + {ϵ}_{i} ) ) \qquad ( 4 )$$

In the uniform incremental strategy (inifI), n≤q samples are sampled uniformly log(Q) times. Then using each sample of the n samples as centers, q/n examples are sampled and queried. Let each of the cdfs induced by each of the centers through Gaussian sampling be denoted by Fᵢ^{Nj,k}(.), where j denotes the iteration number that goes up to log(Q) and k denotes the kth sampled prototype/center.

Lemma 3. The lower bound of the error probability of unifI in a region I is given by Equation (5).

$$P [ {\hat{f}}_{i}^{*} - {f}_{i}^{*} \leq {ϵ}_{i} ] \geq 1 - exp ( - max [ ( q / n ) {F}_{i}^{Nj , k} ( {f}_{i}^{*} + {ϵ}_{i} ) ] ) j ∈ \{ 1 , … , log ( Q ) \} , k ∈ \{ 1 , … , n \} \qquad ( 5 )$$

Equation (5) conveys the insight that finding a good prototype r_{j,k} (implying that Fᵢ^{Nj,k}(fᵢ*+ϵᵢ) is high) will lead to a higher (i.e., better) lower bound than in the uniform case. Intuitively, if a good prototype is found, then exploring the region around the good prototype should be beneficial to find a good estimate of fᵢ*.

The adaptive incremental strategy (adaptI), which is possibly the most complex strategy, adaptively explores in more promising areas of the input space unlike the other two strategies of uniform (unif) and uniform incremental (unifI). Let the cdfs induced by each of the centers through Gaussian sampling be denoted by Fᵢ^{Nj,k}(.), where j denotes the iteration number that goes up to log(Q) and k denotes the kth sampled prototype for a given n.

Lemma 4. Without loss of generality, Fᵢ^{Nj,k}(.)≤Fᵢ^{Nj,k+1}(.)∀j∈{1, . . . log(Q)}, k∈{1, . . . , n−1); i.e., the first prototype produces the worst estimates of the minimum fidelity, while the n^{th} prototype produces the best fidelity, the error probability of adaptI in a region i can be lower bounded via Equation (6).

$$P [ {\hat{f}}_{i}^{*} - {f}_{i}^{*} \leq {ϵ}_{i} ] \geq 1 - exp ( - max [ ( \frac{( n - 1 ) q}{n log n} ) {F}_{i}^{Nj , n} ( {f}_{i}^{*} + {ϵ}_{i} ) ] ) j ∈ \{ 1 , … , log ( Q ) \} \qquad ( 6 )$$

Lemma 4 shows sampling exponentially around the most promising prototypes unlike the unif and unifI strategies which do not adapt. Hence in practice, fᵢ* is likely to be estimated more accurately with adaptive incremental especially in high dimensions.

It is easy to see that for all the three strategies (unif, unifI, adaptI) asymptotically (i.e. as Q→∞), the lower bound on P[\hat{f}ᵢ*−fᵢ≤ϵᵢ] approaches 1 at an exponential rate for arbitrarily small ϵᵢ, which implies that a region is certified correctly given enough number of queries.

Based on the previous results, Equation 3 can be lower bounded for each of the three strategies in accordance with Equations (7a), (7b), and (7c) which are based on Lemmas 1, 2, 3, and 4.

$$\begin{matrix}{P [ {\hat{f}}_{a}^{*} - {f}_{a}^{*} \leq {ϵ}_{a} , {f}_{b}^{*} - {\hat{f}}_{b}^{*} \leq {ϵ}_{b} ] \geq min 1 - exp ( - {QF}_{i}^{( u )} ( {f}^{*} {a}_{i} , {a}_{i - 1} \leq {ϵ}_{ai} ) ) )}^{c} unif \\ i ∈ \{ 1 , … , c )\end{matrix} \qquad ( 7 a )$$

$$\begin{matrix}{P [ {\hat{f}}_{a}^{*} - {f}_{a}^{*} \leq {ϵ}_{a} , {f}_{b}^{*} - {\hat{f}}_{b}^{*} \leq {ϵ}_{b} ] \geq min 1 - exp ( - max [ q / n ) {F}_{ai}^{Nj , k} ( {f}^{*} {a}_{i} , {a}_{i - 1} + {ϵ}_{ai} ) ] ) )}^{c} unifI \\ j ∈ \{ 1 , … , log ( Q ) \} , k ∈ \{ 1 , … , n \}\end{matrix} \qquad ( 7 b )$$

$$\begin{matrix}{P [ {\hat{f}}_{a}^{*} - {f}_{a}^{*} \leq {ϵ}_{a} , {f}_{b}^{*} - {\hat{f}}_{b}^{*} \leq {ϵ}_{b} ] \geq min 1 - exp ( - max [ ( \frac{( n - 1 ) q}{n log n} ) {F}_{ai}^{Nj , n} ( {f}^{*} {a}_{i} , {a}_{i - 1} + {ϵ}_{ai} ) ] ) )}^{c} adapt I \\ j ∈ \{ 1 , … , log ( Q ) \}\end{matrix} \qquad ( 7 bc )$$

Note that in Algorithm 2, each of the three strategies of unif, unifI and adaptI query the black box model at most Q times in any call to Algorithm 2.

### 6. Special Cases

Section 4 derived (with minimal assumptions) bounds on the probability of error in estimating minimum fidelities f*. These bounds converge exponentially with Q for arbitrary fidelity cdfs F(.). However, the cdfs are generally unknown. Section 5.1 provides a partial characterization of Fᵢ(.) in a piecewise linear setting and a cdf-free result in the asymptotic setting. Section 5.2 discusses settings where the certification region can be identified more efficiently using the strategies of embodiments of the present invention.

### 6.1. Characterizing CDFS Fᵢ(.)

### 6.1(1) Piecewise Linear Black Box Case

Several popular classes of models are piecewise linear or piecewise constant; for example, neural networks with Rectified Linear Unit (ReLU) activations, trees and tree ensembles, including oblique trees and model trees. Provided in embodiments of the present invention is a partial characterization of the cdfs Fᵢ(.) for such piecewise linear black box functions g: R^{d}→[0, 1], a linear explanation function e_{y}: R^{d}→[0, 1] estimated for the point y∈R^{d}, and the following fidelity function in Equation (8).

$${f}_{y} ( x ) {=}^{Δ} 1 - \vert g ( x ) - {e}_{y} ( x ) \vert \qquad ( 8 )$$

Assume that the black box g has t≤p linear pieces within the i^{th} region Rᵢ. In the s^{th} piece, s=1, . . . , t, g can be represented as a linear function gₛ(x)=βₛ^{T}x, where βₛ∈R^{d}. Moreover, the s^{th} piece is geometrically a polytope denoted as P_{i,s}⊂R^{d}. The explanation e_{y}(x)=α_{y}^{T}x is linear throughout. Thus within the s^{th} piece, the difference Δₛ(x)=gₛ(x)−e_{y}(x) that determines the fidelity is also linear, Δₛ(x)=(βₛ−α_{y})^{T}x.

The unif strategy where examples are sampled uniformly from Rᵢ is next considered. The distribution of fidelity values is a mixture of t distributions, one t distribution corresponding to each linear piece of g in accordance with Equation (9).

$${F}_{i} ( \cdot ) = {\sum }_{s = 1}^{t} {π}_{s} {F}_{i , s} ( \cdot ) where {\sum }_{s = 1}^{t} {π}_{s} = 1 \qquad ( 9 )$$

In the uniform case (unif), the probability Is that the s^{th} piece is active is given by the ratio of volumes πₛ=vol(P_{i,s}∩Rᵢ)/vol(Rᵢ). The cdf F_{i,s}, or equivalently the corresponding probability density function (pdf), is largely determined by the pdf of Δₛ(x). The property of the latter pdf that is clearest to reason about is its support. The endpoints of the support can be determined by solving two linear programs, Δ_{s,min/max}=min/max_{x∈Pi,s∩R}_{ᵢ}(βₛ−α_{y})^{T}x.

The shape of the pdf is harder to determine. Intuitively, the density of the pdf at a value δ is proportional to the volume of the δ-level set of Δₛ(x) intersected with the polytope, vol({x: (βₛ−α_{y})^{T}x=δ}∩P_{i,s}∩Rᵢ. Given the pdf of Δₛ(x), the absolute value operation in Equation (8) corresponds to folding the pdf over the vertical axis, and the “1-” operation in Equation (8) flips and shifts the result. Overall, F_{i,s} is supported on an interval that is determined by Δ_{s,min} and Δ_{s,max}. A larger difference vector (βₛ−α_{y}) in the s^{th} piece will tend to produce larger Δ_{s,min}, Δ_{s,max} in magnitude, and hence lower fidelities. The minimum fidelity fᵢ* corresponds to the largest |Δ_{s,min}|, |Δ_{s,max}| over s.

The preceding reasoning changes the unifI and adaptI strategies relative to the unif strategy. Instead of a single uniform distribution of examples, the unifI and adaptI strategies have a mixture of Gaussians N_{j,k} indexed by iteration number j and prototype k. Hence Equation (9) is augmented with summations over j and k, and πₛ, F_{i,s} gain indices to become πₛ^{j,k}, F_{i,s}^{j,k}. Instead of volumes, the weight πₛ^{j,k} is given by a ratio of probabilities under each Gaussian: nₛ^{j,k}=P_{Nj,k} (P_{i,s}∩Rᵢ)/P_{Nj,k} (Rᵢ). Multiple pdfs of Δₛ(x) are to be considered, one for each Gaussian N_{j,k}, and the shape of each Gaussian depends on how each Gaussian weights the points in P_{i,s}∩Rᵢ. What does not change however is the support [Δ_{s,min}, Δ_{s,max}] of Δs (x), as this is a geometric quantity depending on the black box g and explanation e_{y} but not the distribution (uniform, N_{j,k}, or otherwise). Hence, the same statements above apply regarding the relationship between the difference vectors (βₛ−α_{y}) and the range of fidelities, mediated by Δ_{s,min}, Δ_{s,max}.

### 6.1(2) Asymptotic Case

Rather than finite sample bounds that depend on cdfs Fᵢ, an asymptotic (Q→∞) perspective could be taken to obtain results that are free of Fᵢ. Extreme Value Theory (EVT) is useful in this regard. Given a setting where the minimum fidelity fᵢ* is finite, it can be assumed that Fᵢ(fᵢ*+ϵᵢ)≈ηϵᵢ^{K} as ϵᵢ→0 for some η>0, κ>0 as is standard in EVT. This would apply to all three strategies (unif, unifI, adaptI). An explicit asymptotic result for the unif strategy naturally follows from EVT. Here in addition to the empirical minimum fidelity \hat{f}ᵢ*, the second-smallest empirical value, denoted as \tilde{f}ᵢ*, is used. Then the result of the L. de Haan reference (L. de Hann, Estimation of the minimum of a function using order statistics, Journal of the American Statistical Association, 76(374):467-469, 1981) implies Equation (10) for the unif strategy, Q→∞, and some probability p∈[0, 1].

$$P ( {\hat{f}}_{i}^{*} - {f}_{i}^{*} \leq ( {\tilde{f}}_{i}^{*} - {f}_{i}^{*} ) / ( {( 1 - p )}^{- 1 / κ} - 1 ) = 1 - p \qquad ( 10 )$$

Equation (10) is reminiscent of Lemma 2 except that the failure probability p is regarded as given. Let the error ϵᵢ^{EVT}=(\tilde{f}ᵢ*−\hat{f}ᵢ*)/((1−p)^{-1/κ}−1) be a function of p as well as the gap \tilde{f}ᵢ*−\hat{f}ᵢ* between the smallest and second-smallest observed values. Put another way, Equation (10) implies a (1−p)-confidence interval [\hat{f}ᵢ*−ϵᵢ^{FVT}, \hat{f}ᵢ*] for the true minimum fᵢ*. As argued in the L. de Haan reference, if κ=d/2 then the confidence interval is completely determined given data.

### 6.2 More Efficient Certification

Having a black box model that is lipschitz or piecewise linear can further speed up embodiments of the present invention. In the lipschitz case, a region can be certified automatically without querying and a non-trivial lb value with additional speedups possible can be set. In the piecewise linear case instead of a head start (i.e., higher lb) the search can be stopped early.

### 7. Experiments

Table 3 depicts results of synthetic experiments to verify the accuracy and efficiency of embodiments of the present invention.

TABLE 3

| | | unif | | unifI | | adaptI | | ZO⁺ | |
|---|---|---|---|---|---|---|---|---|---|
| d | Q | w | Time(s) | w | Time(s) | w | Time(s) | w | Time(s) |
| 1 | 10 | 1 | .001 | 1 | .001 | 1 | .001 | 1 | .012 |
| | 10² | 1 | .006 | 1 | .004 | 1 | .002 | 1 | 1.221 |
| | 10³ | 1 | .055 | 1 | .041 | 1 | .026 | 1 | 1.724 |
| | 10⁴ | 1 | .53 | 1 | .418 | 1 | .189 | 1 | 1.641 |
| 10 | 10 | .06 | .001 | .037 | .001 | .142 | .001 | .3 | .012 |
| | 10² | .082 | .003 | .06 | .007 | .08 | .003 | .1 | .125 |
| | 10³ | .09 | .036 | .085 | .049 | .11 | .044 | .1 | 1.354 |
| | 10⁴ | 1 | .363 | .117 | .615 | .1 | .551 | .1 | 14.944 |
| 10² | 10 | .012 | .001 | .006 | .001 | .007 | .001 | .05 | .031 |
| | 10² | .012 | .005 | .007 | .012 | .008 | .005 | .025 | .3 |
| | 10³ | .011 | .054 | .009 | .158 | .01 | .09 | .012 | 4.072 |
| | 10⁴ | .01 | .632 | .01 | 1.692 | .01 | .51 | .009 | 55.87 |
| 10³ | 10 | 5 × 10⁻³ | .003 | 3 × 10⁻⁴ | .004 | 5 × 10⁻⁴ | .002 | .037 | .307 |
| | 10² | 6 × 10⁻⁴ | .011 | .001 | .073 | 6 × 10⁻⁴ | .044 | .012 | 2.579 |
| | 10³ | 8 × 10⁻⁴ | .077 | .001 | 1.074 | 8 × 10⁻⁴ | .511 | .003 | 28.335 |
| | 10⁴ | .001 | .588 | .001 | 13.786 | 9 × 10⁻⁴ | 5.097 | .001 | 288.523 |
| 10⁴ | 10 | 6.3 × 10⁻⁵ | .012 | 5.1 × 10⁻⁵ | .008 | 5.8 × 10⁻⁵ | .021 | .006 | 3.76 |
| | 10² | 6.6 × 10⁻⁵ | .072 | 7.7 × 10⁻⁵ | 1.187 | 7.8 × 10⁻⁵ | .43 | .004 | 34.602 |
| | 10³ | 8.3 × 10⁻⁵ | .771 | 8.4 × 10⁻⁵ | 12.452 | 8.5 × 10⁻⁵ | 7.91 | 8.4 × 10⁻⁴ | 391.494 |
| | 10⁴ | 8.9 × 10⁻⁵ | 4.83 | 9.1 × 10⁻⁵ | 112.58 | 9.4 × 10⁻⁵ | 88.342 | 9.3 × 10⁻⁵ | 4384.76 |

The synthetic results are for x=[0]^{d}, Z=10, θ=0.75, explanation is slope 0.75 hyperplane, and optimal half-width is 1/d.

A ZO toolbox (Y.-R. Liu, Y.-Q. Hu, H. Qian, C. Qian, and Y. Yu. Zoopt: Toolbox for derivative-free optimization. In SCIENCE CHINA Information Sciences, 2022) is used and referred as a ZO⁺ method, where Algorithm 1 (Ecertify) I Table 1 calls the ZO toolbox as a routine analogous to Algorithm 1 calling the 3 strategies of unif, inifI, and adaptI.

In all of the experiments, the quality metric is fidelity as defined in Equation. (8), and the results are averaged over 10 runs, Q is varied from 10 to 10000, Z is set to 10, θ=0.75, and 4 core machines with 64 GB RAM and 1 NVIDIA A100 GPU are used.

A piecewise linear function with three pieces is created, where the center piece lies between [−2, 2] for each dimension and has an angle of 45 degrees with each axis passing through the origin. The other two pieces start at −2 and 2 respectively and are orthogonal to the center piece. The example to explain is at the origin. The dimensions d are varied from 1 to 10000. The results are for the explanation being a hyperplane with slope 0.75 passing through the origin. The optimal half-width is thus 1/d.

From the synthetic experiments, although all the methods converge close to the true value, methods used in embodiments of the present invention are an order of magnitude or more efficient than ZO+. Also, methods used in embodiments of the present invention converge faster (in terms of queries) in high dimensions (see 100 to 10000 dimensions). Comparing between methods used in embodiments of the present invention, unif seems best (and sufficient) for low dimensions (i.e., up to 100), while unifI is preferable in the intermediate range (i.e., 1000) and adaptI is best when the dimensionality is high (i.e., 10000). Thus, the incremental and finally adaptive ability seems to have an advantage as the search space increases. Although the query is performed (at most) Q times for each strategy, adaptI and unifI are typically slower than unif due to sampling different Gaussians log(Q) times as opposed to sampling Q examples with a single function call, which however will not always happen if a violating example is found faster in each run by the other strategies.

### 8. Invention Flow Charts

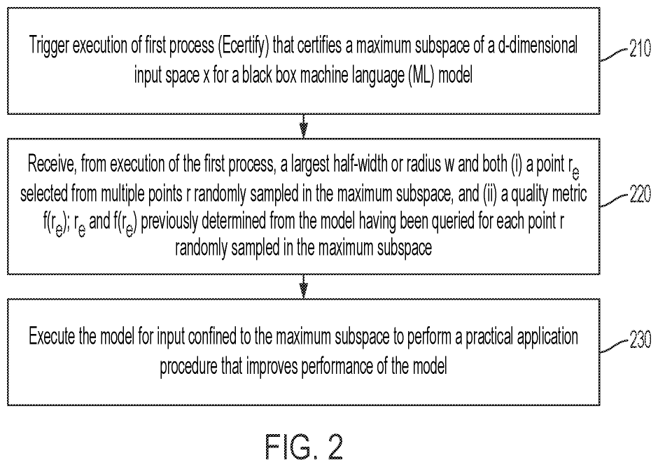

FIG. 2 is a flow chart of a method for certifying a d-dimensional input space x for a model, in accordance with embodiments of the present invention. The model is a black box machine learning (ML) model. The number of dimensions (d) of the input space x is at least 1. Each dimension of the d dimensions pertains to a unique input variable to the model. Thus, x is a vector of dimension d containing d inputs to the model.

For embodiments of the present invention, a black box ML model is a type of model that makes predictions or decisions based on input data, but the internal processing of the input data by the model is not easily understood by humans and cannot be practically performed by a human mind.

Exemplary ML models that may be used in embodiments of the present invention include, inter alia, deep neural networks, decision trees, support vector machines, random forests, etc.

The method of FIG. 2 includes steps 210-230.

Step 210 triggers execution of a first process (Ecertify) that certifies, with respect to the model, a maximum subspace of x that is characterized by a largest half-width or radius (w) centered at x=x₀.

Step 220 receives, from execution of the first process, w and both (i) a point rₑ selected from multiple points r randomly sampled in the maximum subspace, and (ii) a quality metric f(rₑ).

The point rₑ and the quality metric f(rₑ) was previously determined from the model having been queried for each point r randomly sampled in the maximum subspace. The point rₑ was selected on a basis of f(rₑ) having been determined to have a minimum value in comparison to a value of f(r) for all points r randomly sampled in the maximum subspace. The quality metric f(rₑ) satisfies f(rₑ)≥0 for a specified quality threshold θ, which is required for the maximum subspace to be certified.

Step 230 executes the model for input confined to the maximum subspace to perform a practical application procedure that improves performance of the model.

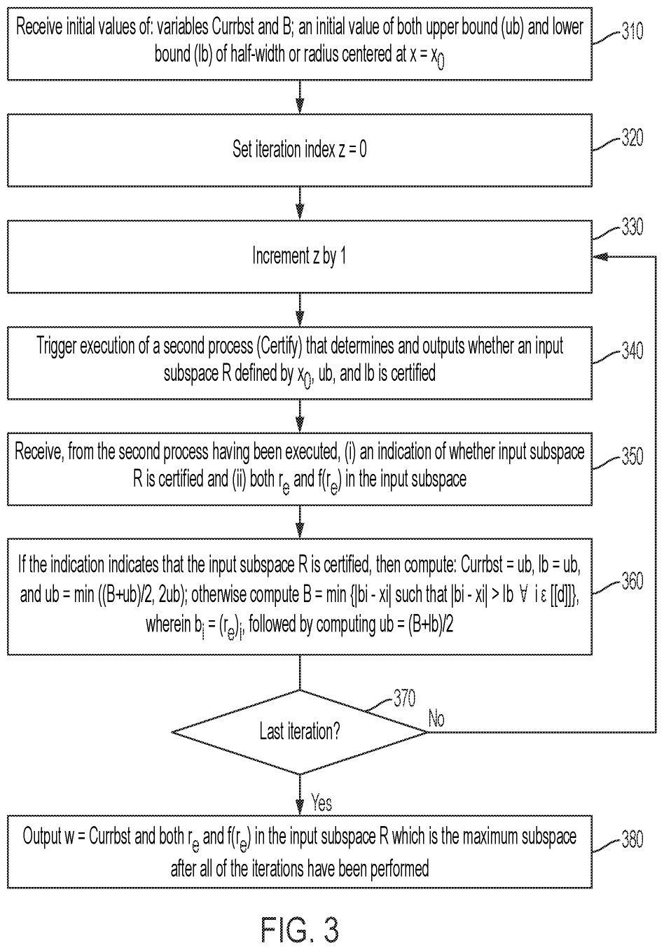

FIG. 3 is a flow chart describing the first process used in the method of FIG. 2, in accordance with embodiments of the present invention. The first process relates to Algorithm 1 in Table 1 described supra.

The first process of FIG. 3 includes steps 310-370.

Step 310 receives initial values of variables Currbst and B and an initial value of both an upper bound (ub) and a lower bound (lb) of a half-width or radius centered at x=x₀. The preceding initial values from be obtained from, inter alia, user input, values of input stored in storage devices or storage media, values of input encoded within program code, etc.

Step 320 sets an iteration index z=0.

Steps 330-370 performs iteration z of an iterative procedure of Z iterations.

Step 330 increments z by 1.

Step 340 triggers execution of a second process (Certify) that determines and “outputs” whether an input subspace R defined by x₀, ub, and lb is certified. The preceding “output” step in the second process also returns program control to the first process that calls the second process.

Generally, for embodiments of the present invention, an “output” step in any given process is defined to be a step that returns both the outputted parameters and program control to the computer program or software that calls the given process.

Step 350 receives, from the second process having been executed, (i) an indication of whether the input subspace R is certified and (ii) both rₑ and f(rₑ) in the input subspace.

In step 360, if the indication indicates that the input subspace R is certified, then Currbst=ub and lb=ub are computed followed by computing ub=min ((B+ub)/2, 2ub); otherwise B=min {|bᵢ−xᵢ| is computed such that |bᵢ−xᵢ|>lb∀i∈[[d]]}, wherein bᵢ=(rₑ)ᵢ, followed by computing ub=(B+lb)/2.

Step 370 determines whether the current iteration z is the last iteration (i.e., whether z=Z). If so, then step 380 is next executed. If not, then program control loops back to step 330 to perform the next iteration z+1.

After the Z iterations have been performed, step 380 outputs w=Currbst and both rₑ and f(rₑ) in the input subspace R which is the maximum subspace after the Z iterations have been performed.

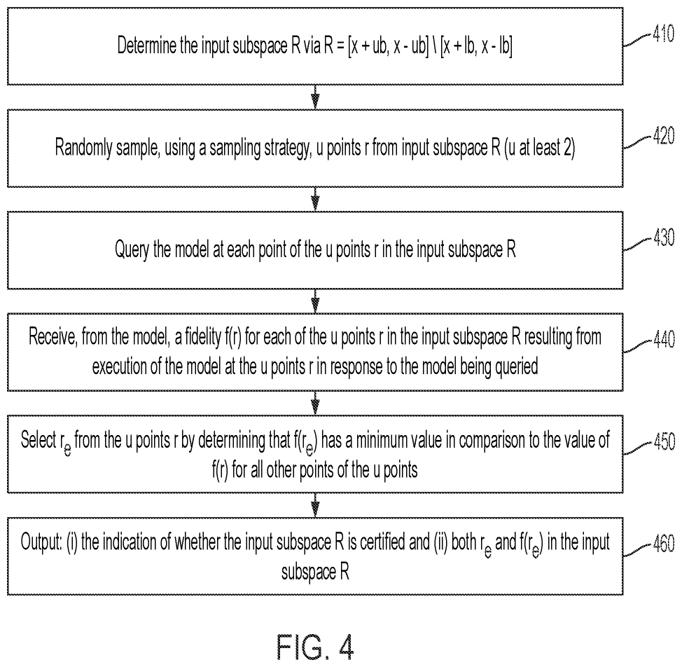

FIG. 4 is a flow chart describing the second process used in the first process of FIG. 3, in accordance with embodiments of the present invention. The second process relates to Algorithm 2 in Table 2 described supra.

The second process of FIG. 4 includes steps 410-460.

Step 410 determines the input subspace R via R=[x+ub, x−ub]\[x+lb, x−lb].

Step 420 randomly samples, using a sampling strategy, u points r from the input subspace R, wherein u≥2.

Step 430 queries the model at each point of the u points r in the input subspace R.

Step 440 receives, from the model, a fidelity f(r) for each of the u points r in the input subspace R resulting from execution of the model at the u points r in response to the model being queried.

Step 450 selects rₑ from the u points r by determining that f(rₑ) has a minimum value in comparison to the value of f(r) for all other points of the u points.

Step 460 outputs: (i) the indication of whether the input subspace R is certified and (ii) both rₑ and f(rₑ) in the input subspace R.

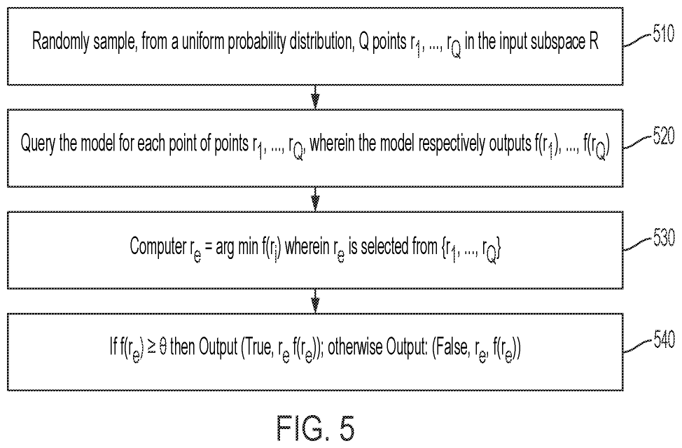

FIG. 5 is a flow chart describing a Uniform (unif) sampling strategy used in the second process of FIG. 4, in accordance with embodiments of the present invention.

The unif sampling strategy of FIG. 5 includes steps 510-540.

Step 510 randomly samples, from a uniform probability distribution, Q points r₁, . . . , r_{Q} in the input subspace R.

Step 520 queries the model for each point of points r₁, . . . , r_{Q}, wherein the model respectively outputs f(r₁), . . . , f(r_{Q}).

Step 530 computes rₑ=arg min f(rᵢ) wherein rₑ is selected from {r₁, . . . , r_{Q}}.

Step 540 compares f(rₑ) with θ. If f(rₑ)>0, then output (True, rₑ, f(rₑ)); otherwise output: (False, rₑ, f(rₑ)). “True” means that the input subspace R is certified. “False” means that the input subspace R is not certified.

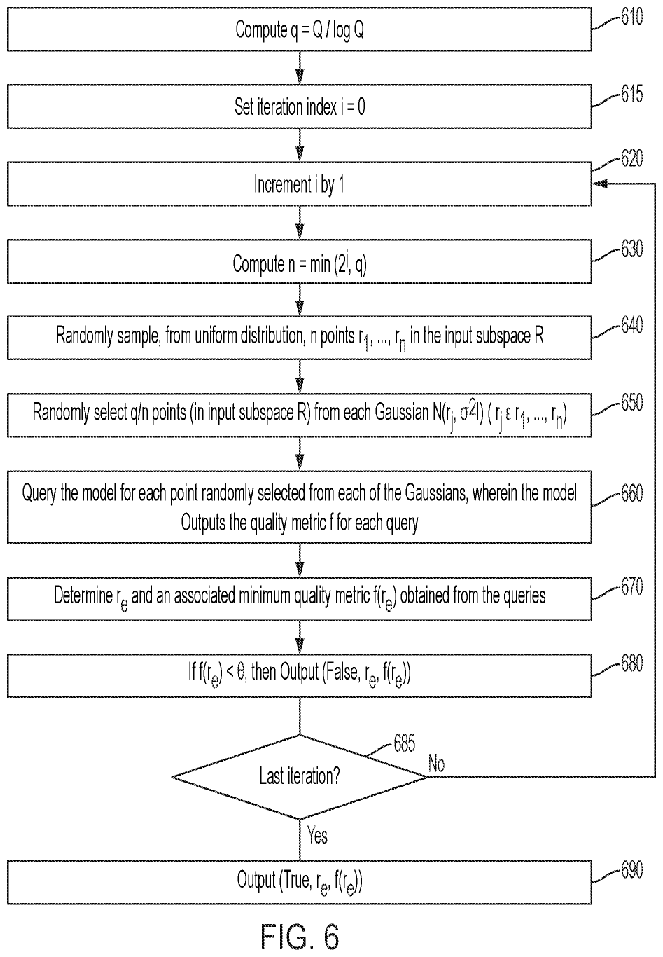

FIG. 6 is a flow chart describing a Uniform Incremental (unifI) sampling strategy used in the second process of FIG. 4, in accordance with embodiments of the present invention.

The unifI sampling strategy of FIG. 6 includes steps 610-690.

Step 610 computes q=Q/log Q.

Step 615 sets iteration index i=0.

Steps 620-685 perform iteration i of an iterative procedure of log Q iterations.

Step 620 increments i by 1.

Step 630 computes n=min (2ⁱ, q).

Step 640 randomly samples, from a uniform probability distribution, n points rᵢ, . . . , rₙ in the input subspace R.

Step 650 randomly selects q/n points (in input subspace R) from each Gaussian probability distribution N (rⱼ, σ²I) (rⱼ∈r₁, . . . , rₙ) characterized by an expected value of rᵢ and a variance σ², wherein I as a d×d unit matrix whose diagonal elements are 1 and whose off diagonal elements are 0.

Step 660 queries the model for each point of the q/n points randomly selected from each of the Gaussian probability distributions, wherein the model outputs the quality metric f for each query.

Step 670 determines rₑ and an associated minimum quality metric f(rₑ) wherein rₑ is selected from the q/n points.

Step 680 compares f(rₑ) with θ. If f(rₑ)<θ, then output (False, rₑ, f(rₑ)).

Step 685 determines whether the current iteration i is the last i iteration (i.e., whether i=log Q). If so, then the loop over i is exited and step 690 is next executed. If not, then program control loops back to step 620 to perform the next iteration i+1.

Step 690 outputs (True, rₑ, f(rₑ)).

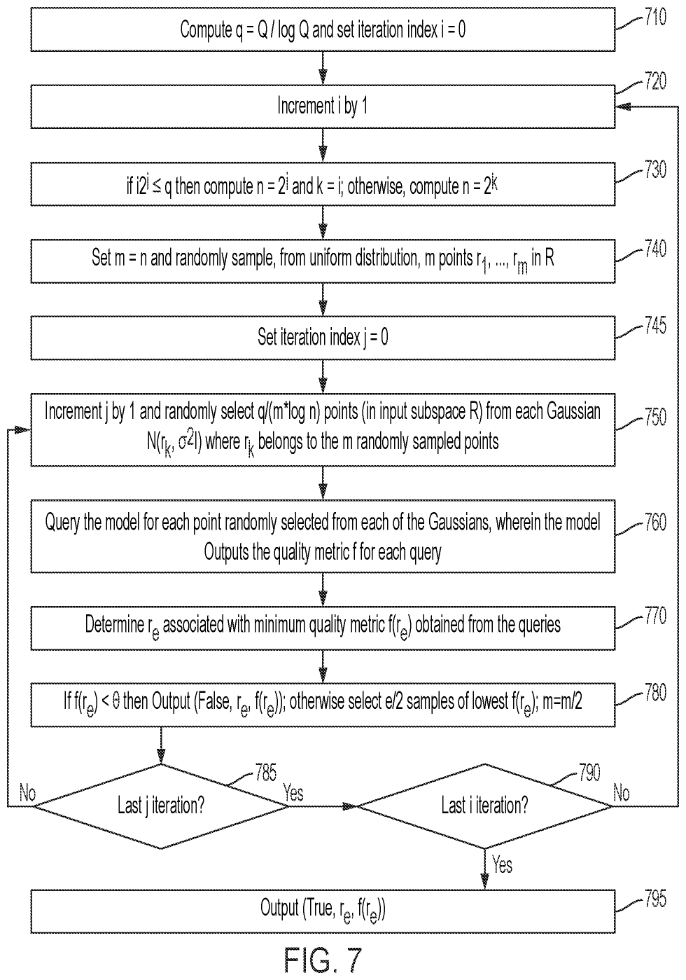

FIG. 7 is a flow chart describing a Adaptive Incremental (adaptI) sampling strategy used in the second process of FIG. 4, in accordance with embodiments of the present invention.

The adaptI sampling strategy of FIG. 7 includes steps 710-795.

Step 710 computes q=Q/log Q and sets iteration index i=0.

Steps 720-790 performs iteration i of an iterative procedure of log Q iterations.

Step 720 increments i by 1.

In step 730, if i2ⁱ≤q then n=2ⁱ and k=i; are computed; otherwise, n=2^{k} is computed.

Step 740 sets m=n and randomly samples, from a uniform probability distribution, m points r₁, . . . , rₘ in R.

Step 745 sets an iteration index j=0.

Steps 750-785 performs iteration j of an iterative procedure of log n iterations.

Step 750 increments j by 1 and randomly selects q/(m*log(n)) points, in the input subspace R, from each Gaussian probability distribution N(rₖ,σ²I) (rₖ∈r₁, . . . , rₘ) characterized by an expected value of rₖ and a variance σ².

Step 760 queries the model for each point of the q/(m*log(n)) points randomly selected from each of the Gaussian probability distributions, wherein the model outputs the quality metric f for each query.

Step 770 determines rₑ and an associated minimum quality metric f(rₑ) wherein rₑ is selected from the q/(m*log(n)) points.

Step 780 compares f(rₑ) with θ. If f(rₑ)<θ, then (False, rₑ, f(rₑ)) is outputted; otherwise select m/2 points respectively associated with the lowest samples of f(rₑ) are selected and m=m/2 is computed.

Step 785 determines whether the current iteration j is the last j iteration (i.e., whether j=log n). If so, then the loop over j is exited and step 790 is next executed. If not, then program control loops back to step 750 to perform the next iteration j+1.

Step 790 determines whether the current iteration i is the last i iteration (i.e., whether i=log Q). If so, then the loop over i is exited and step 795 is next executed. If not, then program control loops back to step 720 to perform the next iteration i+1.

Step 795 outputs (True, rₑ, f(rₑ)).

### 9. Practical Application Procedures

Step 230 in the method of FIG. 2 executes the model for input confined to the maximum subspace to perform a practical application procedure that improves performance of the model.

As explained supra, for embodiments of the present invention, the internal processing of the input data by the black box model is not easily understood by humans and cannot be practically performed by a human mind, so that execution of the model for embodiments of the present invention must be performed by a computer or computing device.

Execution of the model to perform the practical application procedure, with the model's input being confined to the maximum subspace, improves performance of the model by assuring that the model's prediction is “valid” due to the quality metric f(rₑ) being equal to or greater than the quality threshold θ. If validity of the model's prediction were not assured, execution of the model may fail a validity test and require repeated modification of input until the model's prediction satisfies a validity test, which increases the computer time for reaching a valid prediction by the model. Thus, embodiments of the present invention provide both predictive validity and computer time efficiency.

A specific practical application procedure, identified in the present disclosure as an Explanation Method Comparison Experiment, that may be performed in accordance with embodiments of the present invention provides a numerical experiment that compares various explanation methods to determine which explanation method is most efficient and most accurate. See, for example, Table 3 described supra. With the model's input being confined to the maximum subspace in the experiment, the number of data points at which the black box model is queried is limited which enables the experiment to be performed in much less time than if the entire input space is used to define the data region for the experiments, which saves computer time and reduces the complexity of the experiment.

A specific practical application procedure, identified in the present disclosure as a Model Retraining Procedure, that may be performed in accordance with embodiments of the present invention includes retraining the black box model to improve the model. The outputted rₑ is used to further refine the input space to be a more useful input space for retraining the model, and the inventive algorithms for embodiments of the present invention can be re-run with either a smaller or larger quality threshold θ to obtain a smaller (but more accurate) input space or a larger range of data points over which the model is retrained.

A specific practical application procedure, identified in the present disclosure as a Region Selective Usage Procedure, that may be performed in accordance with embodiments of the present invention provides selectivity in choosing specific regions in the input space use for applying the model in an improved manner. The method of FIGS. 1-6 is performed multiple times, each performance of the method being for a different input space with respective different maximum subspace, rₑ and f(rₑ) as output. Each different input space is for a different usage or application of the method, so that each different maximum subspace that is outputted, in consideration of rₑ and f(rₑ) outputted for each different maximum subspace, is optimized for a different usage or application of the method.

### 10. Computer System

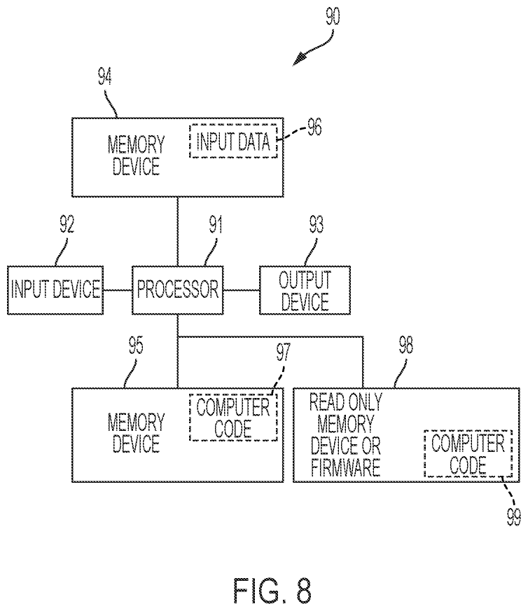

FIG. 8 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for certifying a d-dimensional input space x for a model, said model being a black box machine learning (ML) model, said d being at least 1, said method comprising:
triggering, by one or more processors of a computer system, execution of a first process (Ecertify) that certifies, with respect to the model, a maximum subspace of x that is characterized by a largest half-width or radius (w) centered at x=x₀;
receiving, by the one or more processors from execution of the first process, w and both (i) a point rₑ selected from multiple points r randomly sampled in the maximum subspace, and (ii) a quality metric f(rₑ), said rₑ and f(rₑ) previously determined from the model having been queried for each point r randomly sampled in the maximum subspace, said rₑ selected on a basis of f(rₑ) having been determined to have a minimum value in comparison to a value of f(r) for all points r randomly sampled in the maximum subspace, said f(rₑ) satisfying f(rₑ)≥0 for a specified quality threshold θ; and
executing, by the one or more processors, the model for input confined to the maximum subspace, said executing the model comprising performing a practical application procedure that improves performance of the model.

2. The method of claim 1, said method comprising: executing, by the one or more processors, the first process comprising:
receiving initial values of variables Currbst and B and an initial value of both an upper bound (ub) and a lower bound (lb) of a half-width or radius centered at x=x₀;
performing Z iterations of an iterative process, wherein performing iteration z (z=1, . . . , Z) comprises:
triggering execution of a second process (Certify) that determines and outputs whether an input subspace R defined by x₀, ub, and lb is certified;
receiving, from the second process having been executed, (i) an indication of whether the input subspace R is certified and (ii) both rₑ and f(rₑ) in the input subspace; and
if the indication indicates that the input subspace R is certified, then computing Currbst=ub and lb=ub followed by computing ub=min ((B+ub)/2, 2ub); otherwise computing B=min {|bᵢ−xᵢ| such that |bᵢ−xᵢ|>lb∀i∈[[d]]}, wherein bᵢ=(rₑ)ᵢ, followed by computing ub=(B+lb)/2;
after the Z iterations have been performed, outputting w=Currbst and both rₑ and f(rₑ) in the input subspace R which is the maximum subspace after the Z iterations have been performed.

3. The method of claim 2, said method comprising: executing, by the one or more processors, the second process comprising:
determining the input subspace R via R=[x+ub, x−ub]\[x+lb, x−lb];
randomly sampling, using a sampling strategy, u points r from the input subspace R, wherein u≥2;
querying the model at each point of the u points r in the input subspace R;
receiving, from the model, a fidelity f(r) for each of the u points r in the input subspace R resulting from execution of the model at the u points r in response to the model being queried; and
selecting rₑ from the u points r by determining that f(rₑ) has a minimum value in comparison to the value of f(r) for all other points of the u points,
outputting: (i) the indication of whether the input subspace R is certified and (ii) both rₑ and f(rₑ) in the input subspace R,
wherein u is a function of a parameter Q subject to log Q being a positive integer of at least 2.

4. The method of claim 3, wherein the sampling strategy is Uniform (unif), wherein u=Q, and wherein the u points are sampled from a uniform probability distribution.

5. The method of claim 3, wherein the sampling strategy is Uniform Incremental (unifI), and wherein said executing the second process comprises:
computing q=Q/log Q;
setting an iteration index i to 0;
performing a loop over the iteration index i from i=1 to i=log Q, wherein performing a next iteration of the loop over i comprises:
incrementing i by 1;
computing n=min (2ⁱ, q);
randomly sampling, from a uniform probability distribution, n points r₁, . . . , rₙ in the input subspace R;
randomly selecting q/n points, in the input subspace R, from each Gaussian probability distribution N (rⱼ,σ²I) (rⱼ∈r₁, . . . , rₙ in R) characterized by an expected value of rᵢ and a variance σ², wherein I as a d×d unit matrix;
querying the model for each point of the q/n points randomly selected from each of the Gaussian probability distributions, wherein the model outputs the quality metric f for each query;
determining rₑ and an associated minimum quality metric f(rₑ) wherein rₑ is selected from the q/n points;
determining whether f(rₑ)<θ and if so then outputting (False, rₑ, f(rₑ));
if i<log Q then looping back to said incrementing i to perform the next iteration of the loop over i, otherwise exiting the loop over i followed by outputting (True, rₑ, f(rₑ)).

6. The method of claim 3, wherein the sampling strategy is Adaptive Incremental (adaptI), and wherein said ascertaining and outputting comprises:
computing q=Q/log Q;
setting an iteration index i to 0;
performing a loop over the iteration index i from i=1 to i=log Q, wherein performing a next iteration of the loop over i comprises:
incrementing i by 1;
if i2ⁱ≤q then computing n=2i and k=i, otherwise computing n=2^{k};
setting m=n;
randomly sampling, from a uniform probability distribution, m points r₁, . . . , rₘ in the input subspace R;
setting an iteration index j to 0;
performing a loop over the iteration index j from j=1 to j=log n, wherein performing a next iteration of the loop over j comprises:
incrementing j by 1;
randomly selecting q/(m*log(n)) points, in the input subspace R, from each Gaussian probability distribution N (rₖ,σ²I) wherein rₖ∈the m randomly sampled points;
querying the model for each point of the q/(m*log(n)) points randomly selected from each of the Gaussian probability distributions, wherein the model outputs the quality metric f for each query;
determining rₑ and an associated minimum quality metric f(rₑ) wherein rₑ is selected from the q/(m*log(n)) points;
determining whether f(rₑ)<θ and if so then outputting (False, rₑ, f(rₑ)), otherwise selecting m/2 points respectively associated with the lowest samples of f(rₑ) and computing m=m/2;
if j<log n then branching to said incrementing j to perform the next iteration of the loop over j, otherwise exiting the loop over j;
if i<log Q then branching to said incrementing i to perform the next iteration of the loop over i, otherwise exiting the loop over i followed by outputting (True, rₑ, f(rₑ)).

7. The method of claim 1, wherein said performing the practical application procedure comprises performing an Explanation Method Comparison Experiment, a Model Retraining Procedure, or a Region Selective Usage Procedure.

8. A computer program product, comprising one or more computer readable hardware storage devices having computer readable program code stored therein, said program code containing instructions executable by one or more processors of a computer system to implement a method for certifying a d-dimensional input space x for a model, said model being a black box machine learning (ML) model, said d being at least 1, said method comprising:
triggering, by one or more processors of a computer system, execution of a first process (Ecertify) that certifies, with respect to the model, a maximum subspace of x that is characterized by a largest half-width or radius (w) centered at x=x₀;
receiving, by the one or more processors from execution of the first process, w and both (i) a point rₑ selected from multiple points r randomly sampled in the maximum subspace, and (ii) a quality metric f(rₑ), said rₑ and f(rₑ) previously determined from the model having been queried for each point r randomly sampled in the maximum subspace, said rₑ selected on a basis of f(rₑ) having been determined to have a minimum value in comparison to a value of f(r) for all points r randomly sampled in the maximum subspace, said f(rₑ) satisfying f(rₑ)≥θ for a specified quality threshold θ; and
executing, by the one or more processors, the model for input confined to the maximum subspace, said executing the model comprising performing a practical application procedure that improves performance of the model.

9. The computer program product of claim 8, said method comprising: executing, by the one or more processors, the first process comprising:
receiving initial values of variables Currbst and B and an initial value of both an upper bound (ub) and a lower bound (lb) of a half-width or radius centered at x=x₀;
performing Z iterations of an iterative process, wherein performing iteration z (z=1, . . . , Z) comprises:
triggering execution of a second process (Certify) that determines and outputs whether an input subspace R defined by x₀, ub, and lb is certified;
receiving, from the second process having been executed, (i) an indication of whether the input subspace R is certified and (ii) both rₑ and f(rₑ) in the input subspace; and
if the indication indicates that the input subspace R is certified, then computing Currbst=ub and lb=ub followed by computing ub=min ((B+ub)/2, 2ub); otherwise computing B=min {|bᵢ−xᵢ| such that |bᵢ−xᵢ|>lb∀i∈[[d]]}, wherein bᵢ=(rₑ)ᵢ, followed by computing ub=(B+lb)/2;
after the Z iterations have been performed, outputting w=Currbst and both rₑ and f(rₑ) in the input subspace R which is the maximum subspace after the Z iterations have been performed.

10. The computer program product of claim 9, said method comprising: executing, by the one or more processors, the second process comprising:
determining the input subspace R via R=[x+ub, x−ub]\[x+lb, x−lb];
randomly sampling, using a sampling strategy, u points r from the input subspace R, wherein u≥2;
querying the model at each point of the u points r in the input subspace R;
receiving, from the model, a fidelity f(r) for each of the u points r in the input subspace R resulting from execution of the model at the u points r in response to the model being queried; and
selecting rₑ from the u points r by determining that f(rₑ) has a minimum value in comparison to the value of f(r) for all other points of the u points,
outputting: (i) the indication of whether the input subspace R is certified and (ii) both rₑ and f(rₑ) in the input subspace R,
wherein u is a function of a parameter Q subject to log Q being a positive integer of at least 2.

11. The computer program product of claim 10, wherein the sampling strategy is Uniform (unif), wherein u=Q, and wherein the u points are sampled from a uniform probability distribution.

12. The computer program product of claim 10, wherein the sampling strategy is Uniform Incremental (unifI), and wherein said executing the second process comprises:
computing q=Q/log Q;
setting an iteration index i to 0;
performing a loop over the iteration index i from i=1 to i=log Q, wherein performing a next iteration of the loop over i comprises:
incrementing i by 1;
computing n=min (2ⁱ, q);
randomly sampling, from a uniform probability distribution, n points r₁, . . . , rₙ in the input subspace R;
randomly selecting q/n points, in the input subspace R, from each Gaussian probability distribution N (rⱼ,σ²I) (rⱼ∈r₁, . . . , rₙ in R) characterized by an expected value of rᵢ and a variance σ², wherein I as a d×d unit matrix;
querying the model for each point of the q/n points randomly selected from each of the Gaussian probability distributions, wherein the model outputs the quality metric f for each query;
determining rₑ and an associated minimum quality metric f(rₑ) wherein rₑ is selected from the q/n points;
determining whether f(rₑ)<θ and if so then outputting (False, rₑ, f(rₑ));
if i<log Q then looping back to said incrementing i to perform the next iteration of the loop over i, otherwise exiting the loop over i followed by outputting (True, rₑ, f(rₑ)).

13. The computer program product of claim 10, wherein the sampling strategy is Adaptive Incremental (adaptI), and wherein said ascertaining and outputting comprises:
computing q=Q/log Q;
setting an iteration index i to 0;
performing a loop over the iteration index i from i=1 to i=log Q, wherein performing a next iteration of the loop over i comprises:
incrementing i by 1;
if i2ⁱ≤q then computing n=2i and k=i, otherwise computing n=2^{k};
setting m=n;
randomly sampling, from a uniform probability distribution, m points r₁, . . . , rₘ in the input subspace R;
setting an iteration index j to 0;
performing a loop over the iteration index j from j=1 to j=log n, wherein performing a next iteration of the loop over j comprises:
incrementing j by 1;
randomly selecting q/(m*log(n)) points, in the input subspace R, from each Gaussian probability distribution N (rₖ,σ²I) wherein rₖ∈the m randomly sampled points;
querying the model for each point of the q/(m*log(n)) points randomly selected from each of the Gaussian probability distributions, wherein the model outputs the quality metric f for each query;
determining rₑ and an associated minimum quality metric f(rₑ) wherein rₑ is selected from the q/(m*log(n)) points;
determining whether f(rₑ)<θ and if so then outputting (False, rₑ, f(rₑ)), otherwise selecting m/2 points respectively associated with the lowest samples of f(rₑ) and computing m=m/2;
if j<log n then branching to said incrementing j to perform the next iteration of the loop over j, otherwise exiting the loop over j;
if i<log Q then branching to said incrementing i to perform the next iteration of the loop over i, otherwise exiting the loop over i followed by outputting (True, rₑ, f(rₑ)).

14. The computer program product of claim 8, wherein said performing the practical application procedure comprises performing an Explanation Method Comparison Experiment, a Model Retraining Procedure, or a Region Selective Usage Procedure.

15. A computer system, comprising one or more processors, one or more memories, and one or more computer readable hardware storage devices, said one or more hardware storage devices containing program code executable by the one or more processors via the one or more memories to implement a method for certifying a d-dimensional input space x for a model, said model being a black box machine learning (ML) model, said d being at least 1, said method comprising:
triggering, by one or more processors of a computer system, execution of a first process (Ecertify) that certifies, with respect to the model, a maximum subspace of x that is characterized by a largest half-width or radius (w) centered at x=x₀;
receiving, by the one or more processors from execution of the first process, w and both (i) a point rₑ selected from multiple points r randomly sampled in the maximum subspace, and (ii) a quality metric f(rₑ), said rₑ and f(rₑ) previously determined from the model having been queried for each point r randomly sampled in the maximum subspace, said rₑ selected on a basis of f(rₑ) having been determined to have a minimum value in comparison to a value of f(r) for all points r randomly sampled in the maximum subspace, said f(rₑ) satisfying f(rₑ)≥θ for a specified quality threshold θ; and
executing, by the one or more processors, the model for input confined to the maximum subspace, said executing the model comprising performing a practical application procedure that improves performance of the model.

16. The computer system of claim 15, said method comprising: executing, by the one or more processors, the first process comprising:
receiving initial values of variables Currbst and B and an initial value of both an upper bound (ub) and a lower bound (lb) of a half-width or radius centered at x=x₀;
performing Z iterations of an iterative process, wherein performing iteration z (z=1, . . . , Z) comprises:
triggering execution of a second process (Certify) that determines and outputs whether an input subspace R defined by x₀, ub, and lb is certified;
receiving, from the second process having been executed, (i) an indication of whether the input subspace R is certified and (ii) both rₑ and f(rₑ) in the input subspace; and
if the indication indicates that the input subspace R is certified, then computing Currbst=ub and lb=ub followed by computing ub=min ((B+ub)/2, 2ub); otherwise computing B=min {|bᵢ−xᵢ| such that |bᵢ−xᵢ|>lb∀i∈[[d]]}, wherein bᵢ=(rₑ)ᵢ, followed by computing ub=(B+lb)/2;
after the Z iterations have been performed, outputting w=Currbst and both rₑ and f(rₑ) in the input subspace R which is the maximum subspace after the Z iterations have been performed.

17. The computer system of claim 16, said method comprising: executing, by the one or more processors, the second process comprising:
determining the input subspace R via R=[x+ub, x−ub]\[x+lb, x−lb];
randomly sampling, using a sampling strategy, u points r from the input subspace R, wherein u≥2;
querying the model at each point of the u points r in the input subspace R;
receiving, from the model, a fidelity f(r) for each of the u points r in the input subspace R resulting from execution of the model at the u points r in response to the model being queried; and
selecting rₑ from the u points r by determining that f(rₑ) has a minimum value in comparison to the value of f(r) for all other points of the u points,
outputting: (i) the indication of whether the input subspace R is certified and (ii) both rₑ and f(rₑ) in the input subspace R,
wherein u is a function of a parameter Q subject to log Q being a positive integer of at least 2.

18. The computer system of claim 17, wherein the sampling strategy is Uniform (unif), wherein u=Q, and wherein the u points are sampled from a uniform probability distribution.

19. The computer system of claim 17, wherein the sampling strategy is Uniform Incremental (unifI), and wherein said executing the second process comprises:
computing q=Q/log Q;
setting an iteration index i to 0;
performing a loop over the iteration index i from i=1 to i=log Q, wherein performing a next iteration of the loop over i comprises:
incrementing i by 1;
computing n=min (2ⁱ, q);
randomly sampling, from a uniform probability distribution, n points r₁, . . . , rₙ in the input subspace R;
randomly selecting q/n points, in the input subspace R, from each Gaussian probability distribution N (rⱼ,σ²I) (rⱼ∈r₁, . . . , rₙ in R) characterized by an expected value of rᵢ and a variance σ², wherein I as a d×d unit matrix;
querying the model for each point of the q/n points randomly selected from each of the Gaussian probability distributions, wherein the model outputs the quality metric f for each query;
determining rₑ and an associated minimum quality metric f(rₑ) wherein rₑ is selected from the q/n points;
determining whether f(rₑ)<θ and if so then outputting (False, rₑ, f(rₑ));
if i<log Q then looping back to said incrementing i to perform the next iteration of the loop over i, otherwise exiting the loop over i followed by outputting (True, rₑ, f(rₑ)).

20. The computer system of claim 17, wherein the sampling strategy is Adaptive Incremental (adaptI), and wherein said ascertaining and outputting comprises:
computing q=Q/log Q;
setting an iteration index i to 0;
performing a loop over the iteration index i from i=1 to i=log Q, wherein performing a next iteration of the loop over i comprises:
incrementing i by 1;
if i2ⁱ≤q then computing n=2 and k=i, otherwise computing n=2^{k};
setting m=n;
randomly sampling, from a uniform probability distribution, m points r₁, . . . , rₘ in the input subspace R;
setting an iteration index j to 0;
performing a loop over the iteration index j from j=1 to j=log n, wherein performing a next iteration of the loop over j comprises:
incrementing j by 1;
randomly selecting q/(m*log(n)) points, in the input subspace R, from each Gaussian probability distribution N (rₖ,σ²I) wherein rₖ∈the m randomly sampled points;
querying the model for each point of the q/(m*log(n)) points randomly selected from each of the Gaussian probability distributions, wherein the model outputs the quality metric f for each query;
determining rₑ and an associated minimum quality metric f(rₑ) wherein rₑ is selected from the q/(m*log(n)) points;
determining whether f(rₑ)<θ and if so then outputting (False, rₑ, f(rₑ)), otherwise selecting m/2 points respectively associated with the lowest samples of f(rₑ) and computing m=m/2;
if j<log n then branching to said incrementing j to perform the next iteration of the loop over j, otherwise exiting the loop over j;
if i<log Q then branching to said incrementing i to perform the next iteration of the loop over i, otherwise exiting the loop over i followed by outputting (True, rₑ, f(rₑ)).
